(19) United States
(12) Patent Application Publication
(10) Pub. No.: US 2009/0146769 A1
(43) Pub. Date: Jun. 11, 2009

(54) Light-weight, conduction-cooled inductor

(75) Inventors: Frank Z. Feng, Loves Park, IL (US); Steven Schwitters, Rockford, IL (US); Clifford G. Thiel, Lanark, IL (US); Debabrata Pal, Hoffman Estates, IL (US); John Horowy, Rockford, IL (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Hamilton Sundstrand Corporation, Rockford, IL (US)

(21) Appl. No.: 11/999,614

(22) Filed: Dec. 6, 2007

(51) Int. Cl. H01F 27/02

(52) U.S. Cl. 336/90

(57) ABSTRACT

A lightweight inductor for the motor controller of an aircraft starter includes a toroidal inductor core divided into multiple sections that are separated by a thermally conductive, but electrically insulating, material. The inductor core is wound with wire and positioned inside of an electrically and thermally conductive container, which acts as a heat sink and EMI shield, while also reducing eddy currents within the inductor core.

### BACKGROUND

The invention relates generally to inductors. More specifically, the invention relates to a light-weight inductor used in power filters for multi-function motor controllers in aircraft engines.

When starting a traditional aircraft engine, the engine's shaft is rotated to operating speed by a pneumatic starter. Sparks are subsequently delivered to ignite a fuel/air mixture, which then powers the aircraft engine. This pneumatic starter, however, uses heavy components, which reduces the efficiency of the aircraft.

More recently-designed aircraft replace the pneumatic starter with an electric motor mounted on the shaft of the aircraft engine and a motor controller mounted inside the fuselage of the aircraft. Power is delivered to the electric motor from the motor controller by electric cables, and the electric motor rotates the aircraft engine's shaft up to operating speed. After the engine starting process is completed, the same motor controller is used to operate other motors, such as motors powering the Cabin Air Compressor (CAC) and the landing gear. This multi-function motor controller is called the “common motor starter controller” (CMSC). Included in the CMSC are three identical differential mode inductors. Up to 800 amperes (amps) at 0 hertz (Hz) is conducted through these inductors during the engine starting process, and up to 350 amps at 1450 Hz is conducted through these inductors during other motor applications.

Therefore, there is a need in the art for a differential mode inductor for use in a common motor starter controller that minimizes power loss and maximizes the extraction of heat generated by power loss, thereby keeping operating temperature below required limits. The inductor should also generate less heat than conventional inductors and be able to dissipate the heat that is generated over the high current range in which the inductor must function. Also, the inductor should be light in weight, since weight is often a significant factor in aerospace systems.

### SUMMARY OF THE INVENTION

The invention is an inductor with a toroidal core divided into multiple segments, which are separated by electrically insulating material. The inductor is encapsulated in an electrically insulating, but thermally conductive, potting compound, and is housed inside an electrically and thermally conducting can. The inductor is lightweight, works over a broad range of frequencies with low power loss, generates less heat than conventional inductors, and effectively dissipates the heat that is generated.

### BRIEF DESCRIPTION OF THE DRAWINGS

FIG. 1 shows a wound inductor core of an embodiment of the invention.

FIG. 2 shows the inductor core shown in FIG. 1, but without any winding.

FIG. 3 shows the container in which the inductor is placed.

FIG. 4 shows an embodiment of the invention when fully assembled.

FIGS. 5A and 5B show a prior art inductor.

FIG. 6 is a graph showing the inductance in relation to current of an embodiment of the invention compared to a prior art inductor.

### DETAILED DESCRIPTION

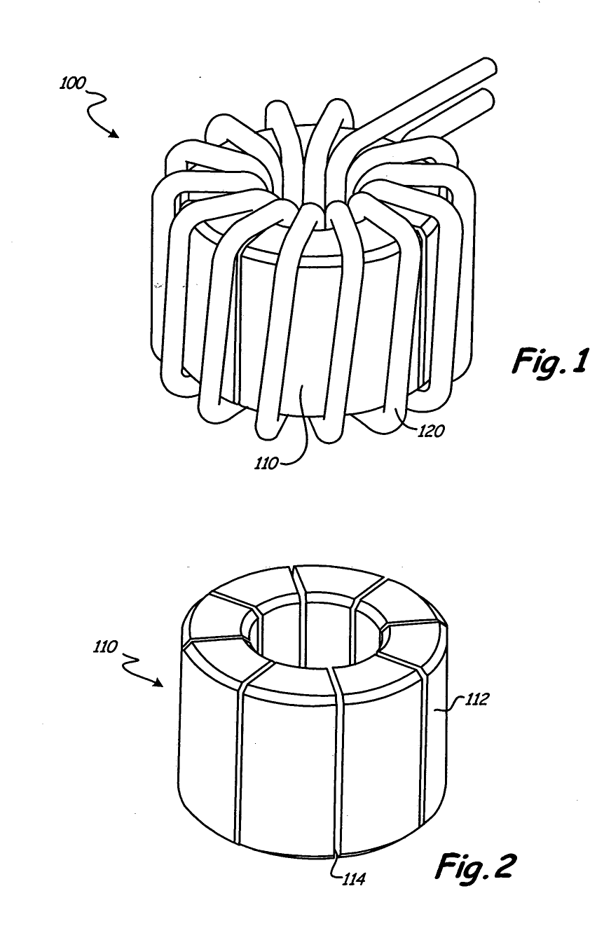

FIG. 1 shows the wound inductor core of an embodiment of the invention. Inductor 100 includes inductor core 110 wrapped with wire 120. Inductor core 110 is in the shape of a toroid, and wire 120 is wound through the hole in the center of inductor core 110 and around the outside surface of inductor core 110. Wire 120 is shown with 11 turns around inductor core 110, but those skilled in the art will recognize that any number of turns could be used to create inductor 100. In one embodiment of the invention, wire 120 is two parallel AWG6 5-bundle Litz wires connected at ends of the winding. This wire is a finely stranded wire in which every strand is insulated with a thin enamel to prevent conduction between wires. AWG6 5-bundle Litz wire exhibits smaller eddy current loss than other wires at higher frequencies, particularly those exceeding 10 kilohertz (kHz).

FIG. 2 shows inductor core 110 without wire 120. Inductor core 110 is made of eight arcuate inductor core sections 112. Each of the eight inductor core sections 112 is separated by a gap 114. Although FIG. 2 shows inductor core 110 with 8 sections 112 and 8 gaps 114, one skilled in the art will recognize that any number of sections and gaps may be used and still fall within the scope of the invention. Inductor core 110 is made of a magnetic material. In one embodiment, inductor core 110 is made of with a thin tape with high permeability, such as 25 micron Metglas® 2605-SA1 magnetic alloy tape. The tape is wrapped to form a toroid and impregnated with an epoxy. The resulting toroid is then cut into 8 pieces, creating inductor core sections 112 and gaps 114. Ideally, gaps 114 should be filled with a material that is both an electrical insulator and a thermal conductor. In one embodiment, gaps 114 are filled with a glass-epoxy laminate, such as Gil, held in place inside gap 114 with a die-attach adhesive, such as Abelbond® adhesive. In another embodiment, a material with a higher thermal conductivity, such as aluminum nitride, is used to fill gaps 114.

In one embodiment of the invention, inductor core 110 has an outside diameter of about 104 millimeters, an inner diameter of about 52 millimeters and a height of about 76 millimeters. In that same embodiment, gaps 114 are about 1.25 millimeters wide.

In inductors energized with alternating current, the alternating magnetic fields produced by the alternating current tend to induce eddy currents within the inductor core. These electric currents in the inductor core must overcome the electrical resistance offered by the core, and eddy currents thus generate heat. The effect is more pronounced at high frequencies, such as those high frequencies found in electric starter controllers in aircraft. Small, multiple gaps 114, as well as the toroidal shape of inductor core 110, reduce the extent of eddy currents in inductor core 110, and thus reduce the amount of heat generated by inductor 100.

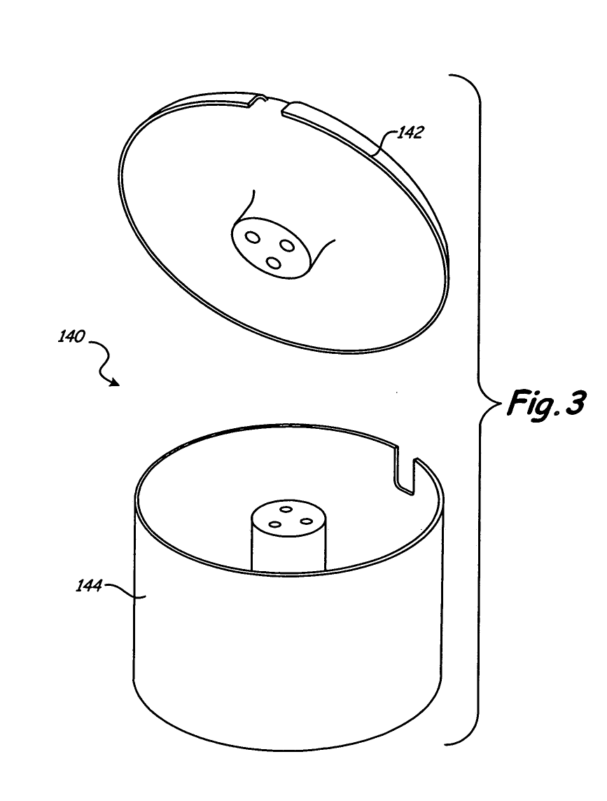

FIG. 3 shows can 140, which include top 142 and bottom 144. Inductor 100 fits inside can 140, which performs three functions. First, can 140 shields inductor 100 from external electromagnetic interference (EMI). Second, can 140 acts as a heat sink for heat generated by inductor 100, conducting much of the heat generated by inductor 100 to can 140. Finally, can 140 reduces eddy currents in inductor core 110. Can 140 acts as a low resistance path to encourage eddy current flow within can 140 induced by stray magnetic fields from gaps 114. The eddy currents within can 140 produce magnetic flux which counters stray magnetic flux due to gaps 114, thus reducing eddy currents in inductor core 110 and thereby further reducing core loss in inductor 100.

Can 140 is made of a material that has a high thermal and electrical conductivity, such as aluminum. The wound inductor 100 is encapsulated in a thermally conductive, but electrically insulating, potting compound, such as Stycast® 5954. The encapsulated inductor 100 is housed inside of can 140. Can 140 typically exhibits about 25 times the thermal conductivity of inductor core 110, and is thus able to dissipate much of the heat generated by inductor 100. Can 140 is typically mounted to a cold plate (not shown) to facilitate heat dissipation. In one embodiment of the invention, the bottom surface of can 140 is flat, in order to maximize heat dissipation between the bottom of can 140 and the cold plate. Also, a flat-bottomed can allows this inductor to be used with a liquid-cooled cold plate.

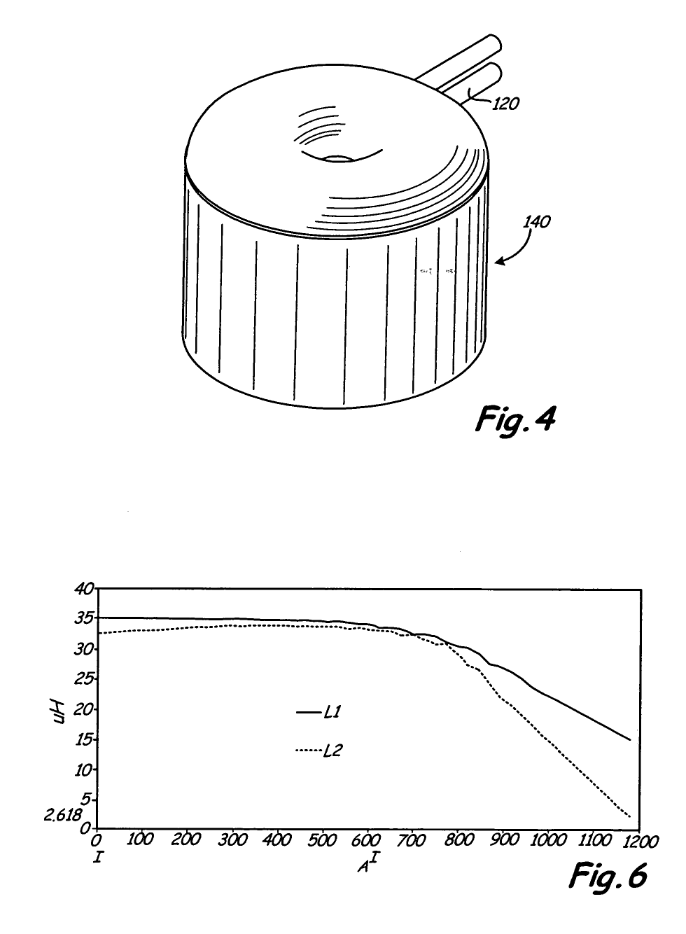

FIG. 4 shows the fully assembled invention in which inductor 100 (not shown in FIG. 4) is inside of metal can 140, with top 142 and bottom 144 in their assembled positions.

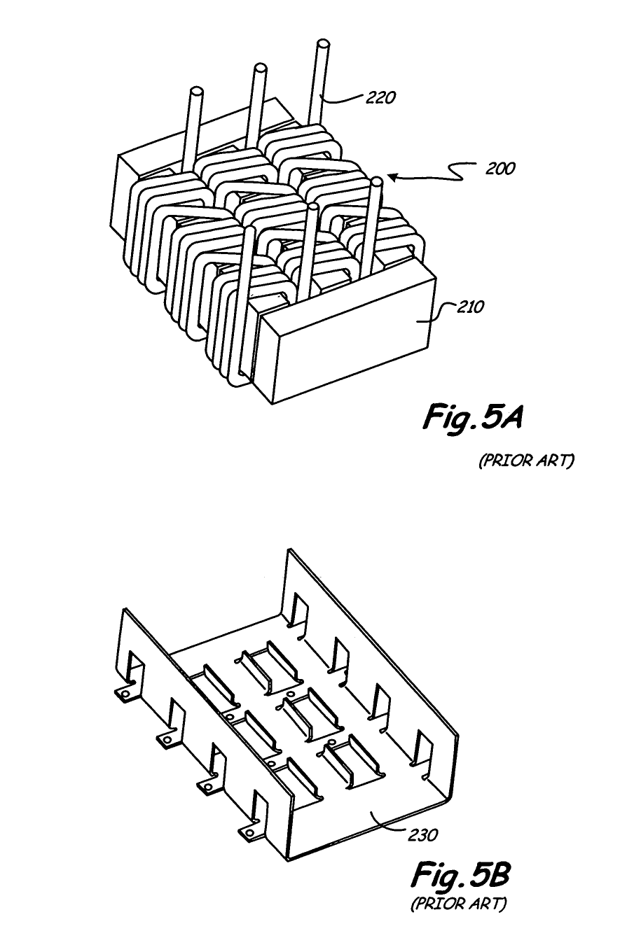

FIG. 5A and FIG. 5B show a prior art inductor. In FIG. 5A, inductor 200 includes rectangular inductor core 210 and wire 220. Prior art inductor 200 fits inside heat sink 230, which is shown in FIG. 5B. Prior art inductor 200 generates a magnetic flux that impinges on heat sink 230, generating an electrical eddy current that runs through heat sink 230, generating substantial heat. Thus, in the prior art, heat sink 230 actually generates heat in addition to acting as a heat sink for inductor 200. In contrast, in the present invention, there is no magnetic flux impinging on can 140, so the heat generated by can 140, which also acts as a heat sink in the present invention, is nearly zero.

FIG. 6 is a graph comparing the inductor of the present invention with the prior art inductor shown in FIG. 5. In FIG. 6, the x-axis represents current in amps (A) and the y-axis represents inductance in microhenries (μH). The curve identified as L1 in FIG. 6 shows the inductance over a range of current of an embodiment of the invention, while the curve L2 shows the inductance of a prior art inductor over the same range of current.

In order for the motor controller of an aircraft to function properly, the inductor must maintain high inductance at a high current. Ideally, as current rises from 0 to 400 amps, the inductance should be constant. The graph of FIG. 6 shows that the present invention (curve L1 in FIG. 6) produces greater inductance over the desired current range than a prior art inductor (curve L2 in FIG. 6) and also produces stable inductance as the current rises from 0 to 400 amps.

The present invention is a lightweight inductor assembly that may be used in the motor controller of an aircraft starter. The wound inductor core is positioned inside of a thermally conductive, but electrically insulating, container, which acts as a heat sink and EMI shield, while also reducing eddy currents within the inductor core. The aircraft starter is able to function with multiple applications, yet still dissipate the heat of the inductor. The present invention performs better than prior art inductors, while also demonstrating less power loss and greater heat dissipation than prior art inductors. The invention also performs well in extreme conditions. For example, in high current conditions, such as those found when starting an aircraft engine, the gaps in the inductor core prevent the inductor core from becoming saturated. In high frequency conditions, losses due to eddy currents are minimized by the toroidal shape of the inductor core and the use of a can around the inductor.

Although the present invention has been described with reference to preferred embodiments, workers skilled in the art will recognize that changes may be made in form and detail without departing from the spirit and scope of the invention.

1. An inductor assembly comprising:
a toroidal magnetic inductor core divided into a plurality of arcuate sections;
an electrically insulating material disposed between each of the arcuate sections;
wiring wrapped around the magnetic inductor core; and
an electrically and thermally conducting container surrounding the inductor core and wiring.

2. The inductor assembly of claim 1 wherein the wiring comprises Litz wire.

3. The inductor assembly of claim 1 wherein the inductor core comprises Metglas® 2605-SA1 tape.

4. The inductor assembly of claim 1 wherein the electrically insulating material comprises epoxy.

5. The inductor assembly of claim 1 wherein the electrically insulating material comprises aluminum nitride.

6. The inductor assembly of claim 1 wherein the container comprises aluminum.

7. An inductor assembly comprising:
a plurality of arcuate sections of magnetic material combined to form a toroidal inductor core;
a plurality of electrically insulating layers separating the plurality of arcuate sections;
wiring wrapped around the inductor core; and
an electrically and thermally conducting container surrounding the inductor core and wiring.

8. The inductor assembly of claim 7 wherein the wiring comprises Litz wire.

9. The inductor assembly of claim 7 wherein the inductor core comprises Metglas® 2605-SA1 tape.

10. The inductor assembly of claim 7 wherein the electrically insulating material comprises epoxy.

11. The inductor assembly of claim 7 wherein the electrically insulating material comprises aluminum nitride.

12. The inductor assembly of claim 7 wherein the container comprises aluminum.
